(19) United States
(12) Patent Application Publication
(10) Pub. No.: US 2026/0000184 A1
(43) Pub. Date: Jan. 1, 2026

(54) Virtual and Augmented Reality Application Store for Makeup Artists

(71) Applicant: ELC MANAGEMENT LLC, Melville, NY (US)

(72) Inventor: Christopher Aidan, Austin, TX (US)

(21) Appl. No.: 18/756,643

(22) Filed: Jun. 27, 2024

(51) Int. Cl. A45D 44/00; G06T 19/00; G06T 19/20; G06V 40/16; H04N 7/15

(52) U.S. Cl. CPC A45D 44/005; G06T 19/006; G06T 19/20; G06V 40/171; H04N 7/157; A45D 2044/007; G06T 2200/24; G06T 2219/2012

(57) ABSTRACT

Techniques for providing virtual makeup looks to a user include receiving a collection of virtual makeup looks designed by a makeup artist, and presenting the collection of virtual makeup looks for a user to select from via a user interface. In response to receiving a selection of one of the virtual makeup looks in the collection, the selected virtual makeup look is obtained for the user. Then facial features of the user or facial features of an avatar representing the user are identified, and the virtual makeup look is adjusted in accordance with characteristics of the facial features of the user or the avatar. The techniques further include presenting the adjusted virtual makeup look overlaid on the user's or the avatar's face, such that components of the adjusted virtual makeup look are overlaid on corresponding portions of the user's or the avatar's face.

### TECHNICAL FIELD

The present disclosure relates generally to systems and methods for creating virtual makeup looks and applying the virtual makeup looks on a user's or avatar's face in an augmented reality (AR) or virtual reality (VR) environment.

### BACKGROUND

The cosmetics industry has seen rapid growth and development worldwide. Makeup artists, beauty enthusiasts, and consumers alike have started using digital platforms to learn, share, and purchase beauty products and services.

However, makeup is typically thought of as a physical product which is applied in a real-world environment. Applying makeup correctly requires a significant amount of time and skill. Then if a consumer or artist is unsatisfied with the look they created, they have to take off all of the makeup they put on and reapply new makeup to create a different look. Additionally, it can take newer consumers a long time to learn which makeup matches their skin tone. Still further, some consumers may be limited in the types of makeup looks they can have based on their facial features or hair characteristics. For example, a makeup artist may create a look for a person with a beard, but the consumer may not have a beard. In another example, a makeup artist may create a look for someone with long hair, while the consumer has short hair.

### SUMMARY

To allow consumers to have more flexibility in the makeup looks they can utilize, a virtual makeup look generation system provides a configuration environment for makeup artists to create virtual makeup looks. These virtual makeup looks may be provided to consumers for example, via a virtual makeup store application. A consumer can then select and/or purchase a virtual makeup look via the virtual makeup store application and then use the virtual makeup look in an augmented reality or virtual reality environment.

For example, the virtual makeup look generation system can apply the virtual makeup look to the consumer's face in an augmented reality environment. Then if the consumer is interacting with other users in an augmented reality environment, the other users will see the consumer with the virtual makeup look applied. For example, the consumer may use the virtual makeup look when video conferencing.

In this manner, a consumer may be able to use the virtual makeup look when meeting with others instead of applying makeup. This can significantly reduce the amount of time it takes for the consumer to prepare in advance of the meeting. Additionally, the consumer can switch between virtual makeup looks seamlessly. The consumer does not have to take off and reapply makeup as in the real world. Still further, the consumer can utilize virtual makeup looks which they would not otherwise be able to use in the real world due to their facial features or hair characteristics.

In another example, the virtual makeup look generation system can apply the virtual makeup look to an avatar's face in a virtual reality environment. For example, a consumer may use an avatar in VR that does not look like them and/or does not have human characteristics. The consumer may choose to apply the virtual makeup look to their avatar, so that other users will see the avatar with the virtual makeup look applied in the VR environment.

In any event, the configuration environment may include a set of tools for designing a virtual makeup look. The set of tools may include user controls for selecting types of virtual makeup such as virtual mascara, virtual eye shadow, virtual eye liner, virtual contour, virtual blush, virtual lipstick, virtual foundation, virtual concealer, virtual bronzer, etc. The set of tools may also include user controls for selecting colors, virtual hairstyles, virtual facial hair, virtual eyebrows, virtual freckles, virtual eyelashes, etc. Additionally, the set of tools may include user controls for selecting relative positions of each component of the virtual makeup look within a face. For example, the configuration environment may present a virtual mannequin to preview the virtual makeup look on.

Then once a makeup artist is done creating a virtual makeup look, the virtual makeup look generation system may store the configuration of the virtual makeup look and the relative positions of each of the components of the virtual makeup look. A makeup artist may also create a collection of virtual makeup looks which may be related to each other or may be each of the virtual makeup looks created by that particular artist.

In the virtual makeup store application, a consumer may browse virtual makeup looks from various makeup artists. The consumer may try on a virtual makeup look by viewing a preview of the virtual makeup look on their face or on their avatar's face. Then once the consumer purchases or obtains the virtual makeup look, the consumer may be able to apply the virtual makeup look in other environments outside of the virtual makeup store application.

In some implementations, the virtual makeup look generation system may adjust the colors of the virtual makeup look in accordance with the consumer's or avatar's skin tone. The makeup artist may select specific colors for the virtual makeup look or ranges of colors for the virtual makeup look. Then the virtual makeup look generation system may select a color within the range which matches the consumer's or avatar's skin tone. In other implementations, the virtual makeup look generation system may select colors which are closest to the colors selected by the makeup artist that match the consumer's or avatar's skin tone.

Also in some implementations, the virtual makeup look generation system may detect real-time movement by the consumer or the avatar to maintain the virtual makeup look over the consumer's or avatar's face as the consumer or avatar moves. For example, the virtual makeup look generation system may detect facial features within a video frame and may overlay corresponding components of the virtual makeup look on the facial features (e.g., eyelashes on the eyes, eyebrows above the eyes, lipstick on the lips, etc.). Then as the consumer moves, the virtual makeup look generation system may detect updated positions of the facial features within the video frame and may overlay components of the virtual makeup look at the updated positions.

One example embodiment of the techniques of this disclosure is a method for providing virtual makeup looks to a user. The method includes receiving, by one or more processors, a collection of virtual makeup looks designed by a makeup artist, and presenting, by the one or more processors via a user interface, the collection of virtual makeup looks for a user to select from. The method also includes receiving, at the one or more processors, a selection by the user of one of the virtual makeup looks in the collection. In response to receiving the selection, the method includes obtaining, by the one or more processors, the selected virtual makeup for the user, and identifying, by the one or more processors, facial features of the user in a camera view or facial features of an avatar representing the user in a virtual reality environment. Additionally, the method includes adjusting, by the one or more processors, the virtual makeup look in accordance with characteristics of the facial features of the user or the avatar, and presenting, by the one or more processors, the adjusted virtual makeup look overlaid on the user's or the avatar's face, such that components of the adjusted virtual makeup look are overlaid on corresponding portions of the user's or the avatar's face.

Another example embodiment of the techniques of this disclosure is a method for providing virtual makeup looks to users. The method includes providing, by one or more processors, a configuration environment for creating virtual makeup looks to one or more makeup artists, obtaining, by the one or more processors, one or more collections of virtual makeup looks from the one or more makeup artists created via the configuration environment, and providing, by the one or more processors, the one or more collections for display to a user. The method also includes receiving, by the one or more processors, a selection from the user of one of the virtual makeup looks in the one or more collections, and storing, by the one or more processors, the selected virtual makeup look in a user profile for the user. In response to receiving a request to apply the selected virtual makeup look, the method includes identifying, by the one or more processors, facial features of the user in a camera view or facial features of an avatar representing the user in a virtual reality environment. Additionally, the method includes adjusting, by the one or more processors, the virtual makeup look in accordance with characteristics of the facial features of the user or the avatar, and providing, by the one or more processors, the adjusted virtual makeup look for display, such that components of the adjusted virtual makeup look are overlaid on corresponding portions of the user's or the avatar's face.

Yet another example embodiment of the techniques of this disclosure is a method for configuring virtual makeup looks. The method includes presenting, by one or more processors, a configuration environment to a makeup artist for creating virtual makeup looks. The configuration environment including a set of tools for designing a virtual makeup look. The set of tools includes user controls for selecting one or more types of makeup, one or more colors, or one or more hairstyles, and for selecting relative positions of each component of the virtual makeup look within a face. The method also includes generating, by the one more processors, a virtual makeup look designed by the makeup artist via the configuration environment based on interactions with the user controls by the makeup artist. Additionally, the method includes providing, by the one or more processors, the virtual makeup look for inclusion in a collection of virtual makeup looks. Each of the virtual makeup looks in the collection is selectable by users for application on the users' faces in an augmented reality environment or on the users' avatars in a virtual reality environment.

### BRIEF DESCRIPTION OF THE DRAWINGS

FIG. 1 illustrates a block diagram of a computer network and system on which a virtual makeup look generation system may operate in accordance with an example aspect of the present disclosure;

FIG. 2 illustrates a block diagram of an example consumer client device which may operate in the system of FIG. 1;

FIG. 3 illustrates a block diagram of an example artist client device which may operate in the system of FIG. 1;

FIG. 4 illustrates an example configuration display which may be presented by the artist client device via a virtual makeup configuration environment;

FIG. 5 illustrates an example virtual makeup look preview which may be presented by the artist client device via the virtual makeup configuration environment;

FIG. 6 illustrates an example collection display which may be presented by the consumer client device via a virtual makeup store application;

FIG. 7 illustrates an example camera view of a video conferencing application which may be presented by the consumer client device and includes user controls for selecting virtual makeup looks to apply to the consumer's face;

FIG. 8 illustrates another example camera view of the video conferencing application which includes a selected virtual makeup look which is applied to the consumer's face;

FIG. 9 illustrates an example display of a VR environment which may be presented by the consumer client device and includes a selected virtual makeup look which is applied to an avatar's face;

FIG. 10 illustrates a flow diagram of an example method for providing virtual makeup looks to a user, which may be executed by the consumer client device;

FIG. 11 illustrates a flow diagram of an example method for providing virtual makeup looks to users, which may be executed by a server device; and

FIG. 12 illustrates a flow diagram of an example method for configuring virtual makeup looks, which may be executed by the artist client device.

### DETAILED DESCRIPTION

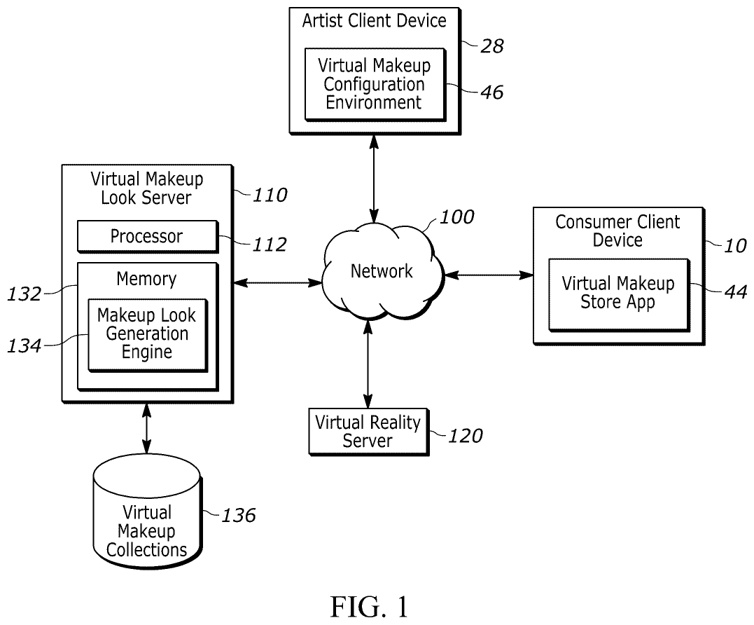

Referring to FIG. 1, an example communication system in which the techniques outlined above can be implemented includes a consumer client device 10 and an artist client device 28, which may each be client computing devices configured to execute a virtual makeup store application 44 and/or a virtual makeup configuration environment 46. In addition to the consumer client device 10 and the artist client device 28, the communication system includes a server device 110, such as a virtual makeup look server configured to provide virtual makeup look collections created by artists in the virtual makeup store, assign virtual makeup looks to consumers who select and/or purchase them, and apply selected virtual makeup looks to a user's or avatar's face in an augmented reality (AR) or virtual reality (VR) environment. The communication system also includes a virtual reality server 120 configured to provide a VR environment which may be presented on a client device 10/28. The virtual reality server 120 may also store an avatar for the consumer. Additionally, the communication system 100 may include an augmented reality server (not shown) or other server for providing an AR environment for a particular application, such as a video conferencing application, a video calling, streaming, or chatting application, a gaming application, a social media application, etc.

As used herein, the term “consumer” refers to a person who obtains or purchases virtual makeup looks, whereas the term “artist” or “makeup artist” refers to a person who designs or creates virtual makeup looks. Generally, the term “user” is used when referring to a person who is operating one of the consumer or artist client devices 10, 28 and is not exclusive of the terms “consumer” and “artist.”

The consumer client device 10, the artist client device 28, the virtual makeup look server 110, the virtual reality server 120, and the augmented reality server (not shown) may be communicatively connected to each other through a network 100. The network 100 may be a public network, such as the Internet, or a private network such as an intranet.

The virtual makeup look server 110 can be communicatively coupled to a database 136 that stores, in an example implementation, virtual makeup collections created by makeup artists via the virtual makeup configuration environment 46. The virtual makeup look server 110 may also store user profiles for consumers in the database 136. A user profile for a consumer may include the virtual makeup looks obtained/purchased by the consumer. In this manner, the consumer may select one the virtual makeup looks from their user profile to apply in an AR or VR environment. More generally, the virtual makeup look server 110 can communicate with one or several databases that store any type of information that can be used in the virtual makeup look environment.

In some implementations, the virtual makeup look server 110 may include several communicatively connected server devices. For example, the virtual makeup look server 110 may store virtual makeup looks obtained/purchased by a consumer in the database 136. The virtual makeup look server 110 may communicate with a video conferencing server to provide the stored virtual makeup look to the video conferencing server. Then the video conferencing server may provide the virtual makeup look to a video conferencing application, where the consumer may select an option to apply the virtual makeup look. In some implementations, when the consumer selects a virtual makeup look to apply, the video conferencing server may provide a camera view of the consumer from the video conferencing application to the virtual makeup look server 110. The virtual makeup look server 110 may then analyze the camera view to identify the user's facial features and adjust the virtual makeup look in accordance with characteristics of the user's facial features.

For example, the virtual makeup look server 110 may identify portions of the user's face, such as the user's eyes, nose, ears, mouth, hair, etc. The virtual makeup look server 110 may then overlay components of the virtual makeup look on corresponding portions of the user's face. More specifically, the virtual makeup look server 110 may overlay virtual lipstick on the user's lips, virtual eyelashes on the user's eyes, virtual eyebrows above the user's eyes, virtual hair on top of the user's head, etc. Additionally, the virtual makeup look server 110 may not overlay a component of the virtual makeup look on a corresponding portion of the user's face if the user is missing the corresponding portion. For example, if the user is missing one of their eyes, the virtual makeup look server 110 may not overlay a virtual eyelash, virtual eye shadow, virtual mascara, virtual eye shadow, virtual eye liner, etc., for the missing eye.

Then the virtual makeup look server 110 may overlay the adjusted virtual makeup look on the user's face in the camera view and may provide the overlay to the video conferencing server/application for presentation. In some implementations, the virtual makeup look server 110 and the video conferencing server may communicate in real-time so that the virtual makeup look server 110 can adjust the overlay of the virtual makeup look in accordance with movement of the user's face in the camera view.

Also, in some implementations, the video conferencing application may communicate with the virtual makeup look server 110 via a virtual makeup application programming interface (API). The virtual makeup look server 110 may expose an API so that the video conferencing application (or any suitable client application) can provide identification information for the consumer and the virtual makeup look server 110 may provide the consumer's virtual makeup looks to choose from. The virtual makeup API may also receive real-time camera views and provide overlays to the video conferencing application or any other suitable client application.

In another example, the virtual makeup look server 110 may communicate with the virtual reality server 120 to provide stored virtual makeup looks for the consumer to the virtual reality server 120. Then the virtual reality server 120 may provide the virtual makeup look to a virtual reality application, where the consumer may select an option to apply the virtual makeup look. In some implementations, when the consumer selects a virtual makeup look to apply, the virtual reality server 120 may provide an image of the consumer's avatar from the virtual reality application to the virtual makeup look server 110. The virtual makeup look server 110 may then analyze the image to identify the avatar's facial features and adjust the virtual makeup look in accordance with characteristics of the avatar's facial features. Then the virtual makeup look server 110 may overlay the adjusted virtual makeup look on the avatar's face in the image and may provide the overlay to the virtual reality server/application for presentation.

Avatars may have more variation in facial features than consumers' faces, because avatars do not need to depict a human. The avatars can depict animals or fictional creatures. As a result, the virtual makeup look server 110 may train a machine learning algorithm to detect facial features on avatars' faces separately from a machine learning algorithm for detecting facial features on people. For example, the virtual makeup look server 110 may detect an eye in the center of the avatar's face, rather than symmetrical eyes on opposite sides of a person's face. In any event, the virtual makeup look server 110 may adjust the virtual makeup look in accordance with characteristics of the avatar's detected facial features. Additionally, the virtual makeup look server 110 may not overlay a component of the virtual makeup look on a corresponding portion of the avatar's face if the avatar is missing the corresponding portion. In the example above where the avatar has one eye in the center of its face, the virtual makeup look server 110 may not overlay virtual eyelashes for two eyes, and instead may overlay one virtual eyelash on the avatar's eye in the center of its face.

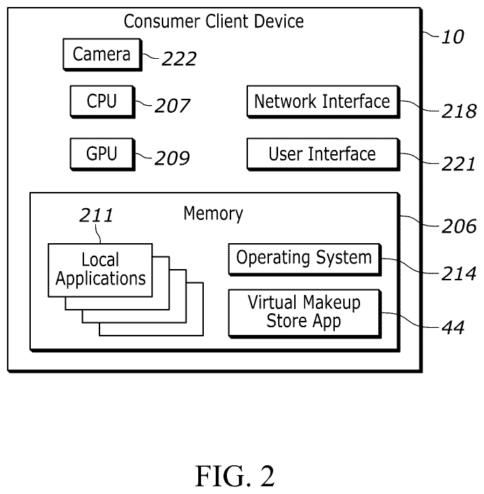

In an example implementation, as shown in FIG. 2, the consumer client device 10 may be a smart phone, a tablet, a laptop computer, a desktop computer, a wearable device, such as a smart watch or smart glasses, a virtual reality headset, or any other suitable client computing device. The consumer client device 10 may include a memory 206, one or more processors 207, a graphics processing unit (GPU) 209, a network interface 218, a user interface (UI) 221 and one or several sensors 222 including a camera. The memory 206 can be a non-transitory memory and can include one or several suitable memory modules, such as random access memory (RAM), read-only memory (ROM), flash memory, other types of persistent memory, etc. The UI 221 may be a touch screen, for example.

Depending on the implementation, the one or more sensors 222 can include a camera, a global positioning system (GPS) module to detect the position of the consumer client device 10, a compass to determine the direction of the consumer client device 10, a gyroscope to determine the rotation and tilt, an accelerometer, etc.

The memory 206 stores an operating system (OS) 214, which can be any type of suitable mobile or general-purpose operating system. The OS 214 can include API functions that allow applications (such as the virtual makeup store application 44 and another application) to interface with each other, or to retrieve, for example, sensor readings. For example, a software application configured to execute on the consumer client device 10 can include instructions that invoke an OS 214 API for retrieving a current location and orientation of the consumer client device 10 at that instant. The API can also return a quantitative indication of how certain the API is of the estimate (e.g., as a percentage).

The memory 206 also stores local applications 211 and the virtual makeup store application 44 which is configured to provide collections of virtual makeup looks created by makeup artists to the consumer. The virtual makeup store application 44 may include user controls for browsing and/or previewing the virtual makeup looks. For example, the virtual makeup store application 44 may present the virtual makeup looks on a virtual mannequin or may present the virtual makeup looks on the consumer's or avatar's face. Additionally, the virtual makeup store application 44 may detect facial features of the consumer or avatar (e.g., via a camera view or image of the consumer or avatar) and may adjust the virtual makeup look in accordance with characteristics of the user's or avatar's detected facial features. The virtual makeup store application 44 may also include user controls for the user to obtain/purchase one of the virtual makeup looks. In response to selecting a user control to obtain/purchase a particular virtual makeup look, the virtual makeup store application 44 may store the particular virtual makeup look in a user profile for the consumer. The virtual makeup store application 44 may store the particular virtual makeup look adjusted to the user's facial features. The virtual makeup store application 44 may also store an instance of the particular virtual makeup look adjusted to the facial features of the user's avatar.

Then the consumer may apply the adjusted virtual makeup look to their face or their avatar's face within the virtual makeup store application 44 or another application that communicates with the virtual makeup store application 44, for example via the virtual makeup API. For example, the local applications 211 may include a video conferencing application, a video calling, streaming, or chatting application, a gaming application, a social media application, etc. The local application 211 may communicate with the virtual makeup store application 44 to retrieve the virtual makeup looks for the consumer and present a selected virtual makeup look that is adjusted and applied to the consumer's face or the face of the consumer's avatar.

It is noted that although FIG. 2 illustrates the virtual makeup store application 44 as a standalone application, the functionality of the virtual makeup store application 44 also can be provided in the form of an online service accessible via a web browser executing on the consumer client device 10, as a plug-in or extension for another software application executing on the consumer client device 10, etc. The virtual makeup store application 44 generally can be provided in different versions for different respective operating systems. For example, the maker of the consumer client device 10 can provide a Software Development Kit (SDK) for writing or building the virtual makeup store application 44 for the Android™ platform, another SDK for the iOS™ platform, etc.

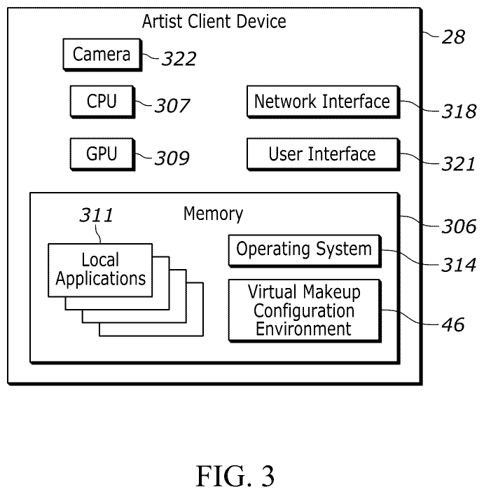

As shown in FIG. 3, the artist client device 28 may be a smart phone, a tablet, a laptop computer, a desktop computer, a wearable device, such as a smart watch or smart glasses, a virtual reality headset, or any other suitable client computing device. The artist client device 28 may include a memory 306, one or more processors 307, a graphics processing unit (GPU) 309, a network interface 318, a user interface (UI) 321 and one or several sensors 322 including a camera. The memory 306 can be a non-transitory memory and can include one or several suitable memory modules, such as random access memory (RAM), read-only memory (ROM), flash memory, other types of persistent memory, etc. The UI 321 may be a touch screen, for example.

Depending on the implementation, the one or more sensors 322 can include a camera, a global positioning system (GPS) module to detect the position of the artist client device 28, a compass to determine the direction of the artist client device 28, a gyroscope to determine the rotation and tilt, an accelerometer, etc.

The memory 306 stores an operating system (OS) 314, which can be any type of suitable mobile or general-purpose operating system. The OS 314 can include API functions that allow applications (such as the virtual makeup configuration environment 46 and another application) to interface with each other, or to retrieve, for example, sensor readings. For example, a software application configured to execute on the artist client device 28 can include instructions that invoke an OS 314 API for retrieving a current location and orientation of the artist client device 28 at that instant. The API can also return a quantitative indication of how certain the API is of the estimate (e.g., as a percentage).

The memory 306 also stores local applications 311 and the virtual makeup configuration environment 46 which is configured to provide a set of tools for a makeup artist to design virtual makeup looks. The makeup artist may store the virtual makeup looks in a collection which may be uploaded to the virtual makeup store application 44. The set of tools may include user controls for selecting types of virtual makeup such as virtual mascara, virtual eye shadow, virtual eye liner, virtual contour, virtual blush, virtual lipstick, virtual foundation, virtual concealer, virtual bronzer, etc. The set of tools may also include user controls for selecting colors, virtual hairstyles, virtual facial hair, virtual eyebrows, virtual freckles, virtual eyelashes, etc. Additionally, the set of tools may include user controls for selecting relative positions of each component of the virtual makeup look within a face. For example, the configuration environment may present a virtual mannequin to preview the virtual makeup look on.

The configuration environment 46 may include a configuration canvas for designing the virtual makeup look which may include a virtual mannequin. The makeup artist may select various types of virtual makeup via the user controls and place the selected types within the configuration canvas. Then the makeup artist may adjust the colors, styles, shading, amount, etc. of each type of virtual makeup within the configuration canvas.

The configuration environment 46 may include user controls for the makeup artist to save a virtual makeup look within a collection or create a new collection. Additionally, the configuration environment 46 may include user controls for selecting whether to save the virtual makeup look within the configuration environment 46 for further editing. Moreover, the configuration environment 46 may include user controls for selecting whether to upload the virtual makeup look or a collection of virtual makeup looks to the virtual makeup store application 44 as a finished look.

It is noted that although FIG. 3 illustrates the virtual makeup configuration environment 46 as a standalone application, the functionality of the virtual makeup configuration environment 46 also can be provided in the form of an online service accessible via a web browser executing on the artist client device 28, as a plug-in or extension for another software application executing on the artist client device 28, etc. The virtual makeup configuration environment 46 generally can be provided in different versions for different respective operating systems. For example, the maker of the artist client device 28 can provide a Software Development Kit (SDK) for writing or building the virtual makeup configuration environment 46 for the Android™ platform, another SDK for the iOS™ platform, etc.

Turning back to FIG. 1, the virtual makeup look server 110 includes one or more processors 112, a network interface (not shown), and a memory 132. The memory 132 may be tangible, non-transitory memory and may include any types of suitable memory modules, including random access memory (RAM), read-only memory (ROM), flash memory, other types of persistent memory, etc. The memory 132 stores instructions executable on the processors 112 which can generate, via a makeup look generation engine 134, adjusted virtual makeup looks to be displayed by the virtual makeup store application 44 or another application 211 overlaying the consumer's face or the face of the consumer's avatar.

The makeup look generation engine 134 may receive a camera view or image from the camera of the consumer client device 10, where the camera view depicts real-world imagery of the consumer's face within the field of view of the camera. The makeup look generation engine 134 may then detect facial features within the camera view. More specifically, the makeup look generation engine 134 may compare features identified in the camera view to features identified in several template objects depicting facial features which are stored in the database 136, for example. For example, the widths and heights of people may be stored as template features along with skin tones for people, the widths and heights of noses, mouths, eyes, and their respective positions relative to each other.

The makeup look generation engine 134 may compare features identified in the camera view from the camera of the consumer client device 10 to the template objects using machine learning techniques, such as random forests, boosting, nearest neighbors, Bayesian networks, neural networks, support vector machines, etc.

More specifically, the makeup look generation engine 134 may identify facial features in the camera view by detecting stable regions within the camera view that are detectable regardless of blur, motion, distortion, orientation, illumination, scaling, and/or other changes in camera perspective. The stable regions may be extracted from the template object using a scale-invariant feature transform (SIFT), speeded up robust features (SURF), fast retina keypoint (FREAK), binary robust invariant scalable keypoints (BRISK), or any other suitable computer vision techniques. In some embodiments, keypoints may be located at high-contrast regions of the template object, such as edges within the template object. A bounding box may be formed around a keypoint and the portion of the camera view created by the bounding box may be a facial feature.

In some implementations, the makeup look generation engine 134 may compare the features for an object to template features for template objects using a nearest neighbors algorithm. The nearest neighbors algorithm may identify template features which are the closest to the features of the object by creating numerical representations of the features to generate feature vectors, such as a pixel width and height of a nose, RGB pixel values for the nose, and pixel distances from the edges of the face to the top, bottom, and sides of the nose, for example. The numerical representations of the features or feature vectors of the object may be compared to the feature vectors of template objects to determine a vector distance between the features of the object and each template object. The makeup look generation engine 134 may then identify a particular facial feature corresponding to an object based on the amount of similarity, or the vector distance in the nearest neighbors algorithm, between the features for the object and the features for template objects that represent a particular facial feature (e.g., a nose). The makeup look generation engine 134 may then identify the facial feature corresponding to an object in the camera view as the facial feature corresponding to the closest template object in the set of template objects. Additionally, the makeup look generation engine 134 may identify characteristics of the facial feature based on characteristics of the bounding box corresponding to the facial feature. For example, the makeup look generation engine 134 may identify the size of the facial feature as the size of the bounding box, the skin tone of the facial feature as the color within the bounding box, etc.

The makeup look generation engine 134 may then detect facial features for the consumer and/or characteristics of the facial features (e.g., the size of various facial features in proportion to the consumer's face, skin tone, etc.) based on the comparison. Then the makeup look generation engine 134 may adjust a virtual makeup look so that components of the adjusted virtual makeup look are overlaid on corresponding portions of the consumer's face.

In some implementations, the makeup look generation engine 134 may additionally or alternatively receive an image of the consumer's avatar used in a VR environment. The makeup look generation engine 134 may then detect facial features within the image. More specifically, the makeup look generation engine 134 may compare the image to several template objects depicting facial features which are stored in the database 136, for example.

For example, the makeup look generation engine 134 may compare the image to the template objects using machine learning techniques, such as random forests, boosting, nearest neighbors, Bayesian networks, neural networks, support vector machines, etc. As mentioned above, the makeup look generation engine 134 may train a first machine learning model for identifying facial features of consumers using a first set of template objects. The makeup look generation engine 134 may also train a second machine learning model for identifying facial features of avatars using a second set of template objects. The first and second machine learning models may be separate machine learning models trained using different training sets.

In any event, the makeup look generation engine 134 may then detect facial features for the avatar and/or characteristics of the facial features (e.g., the size of various facial features in proportion to the avatar's face, skin tone, etc.) based on the comparison. Then the makeup look generation engine 134 may adjust a virtual makeup look so that components of the adjusted virtual makeup look are overlaid on corresponding portions of the avatar's face.

For simplicity, FIG. 1 illustrates the virtual makeup look server 110 as only one instance of a server. However, the virtual makeup look server 110 according to some implementations includes a group of one or more server devices, each equipped with one or more processors and capable of operating independently of the other server devices. Server devices operating in such a group can process requests from the consumer client device 10 or the artist client device 28 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

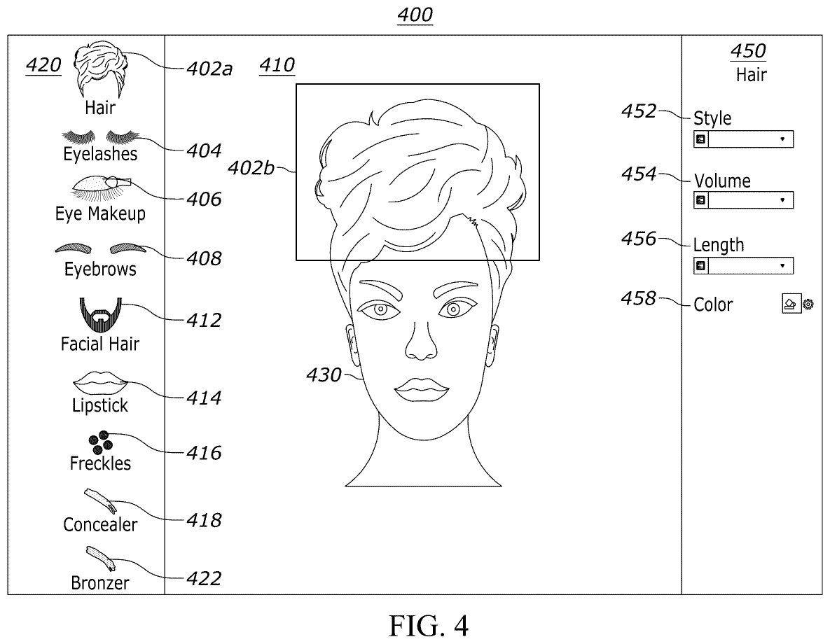

As mentioned above, to design the virtual makeup looks, a makeup artist may execute a virtual makeup configuration environment 46 via their artist client device 28. FIG. 4 illustrates an example configuration display 400 which may be presented by the artist client device 28 via the virtual makeup configuration environment 46. A virtual makeup look may be viewed and/or designed in a configure mode, for example upon selection of a configure button, and/or may be viewed in a preview mode for example upon selection of a preview button. The preview mode presents a preview of the display view as it would appear in the virtual makeup store application, so that a makeup artist may see how the virtual makeup look will look to users.

The configuration display 400 may include a configuration canvas 410 which may present a view of the components of the design of the virtual makeup look as the artist creates the design. In some implementations, the configuration canvas 410 may include a virtual mannequin 430 for the makeup artist to overlay virtual makeup components on. The configuration display 400 also may include graphical user controls for selecting virtual makeup components 402a-422 to include in the virtual makeup look within a makeup component selection pane 420.

The virtual makeup components may include a virtual hair component 402, a virtual eyelashes component 404, a virtual eye makeup component 406, a virtual eyebrows component 408, a virtual facial hair component 412, a virtual lipstick component 414, a virtual freckles component 416, a virtual concealer component 418, a virtual bronzer component 422, a virtual mascara component (not shown), a virtual eye shadow component (not shown), a virtual eye liner component (not shown), a virtual contour component (not shown), a virtual blush component (not shown), a virtual foundation component (not shown), or any other suitable virtual makeup component.

The makeup artist may select virtual makeup components 402a-422 by dragging and dropping the virtual makeup components 402a-422 into the configuration canvas 410 or by using any other suitable graphical user controls. The makeup artist may place the virtual makeup components 402a-422 at corresponding locations on the virtual mannequin 430 and/or relative locations with respect to each other. In this manner, the designed virtual makeup look may include the virtual makeup components selected by the makeup artist at the respective locations in which they are placed on the virtual mannequin 430 and/or relative to each other.

For example, the makeup artist may select the virtual hair button 402a and may drag and drop the virtual hair 402b onto the virtual mannequin's 430 head within the configuration canvas 410. When the virtual hair 402b is selected, the properties of the virtual hair 402b are presented in an editing pane 450. The editing pane 450 may indicate several properties of the virtual hair 402b, such as a hairstyle 452, a volume 454, a length 456, and a color 458. Each of the properties may be adjusted in the editing pane 450 via graphical user controls such as drop-down menus, free-form text fields, or images depicting the property.

For example, the hairstyle 452 property may include a user control, which when selected, presents several images of different hairstyles for the makeup artist to choose from. In response to selecting one of the hairstyles via the user control, the display of the virtual hair 402b in the configuration canvas 410 may change to match the selected hairstyle. The volume 454 and length 456 may include several different volumes and lengths to choose from. Additionally, the color 458 may include a color palette for selecting one of several colors or a free-form text field for entering RGB color values. In some implementations, the editing pane 450 may include a list of colors where the first several colors in the list resemble natural hair colors followed by colors which do not resemble natural hair colors. Additional or alternative adjustable properties may also be presented.

In addition to selecting properties of the virtual hair 402b via the editing pane 450, the makeup artist may select properties of the other virtual makeup components included in the virtual makeup look via the editing pane 450. For example, the makeup artist may select colors for virtual lipstick, virtual blush, virtual foundation, virtual bronzer, etc. In some implementations, the editing pane 450 may include a list of colors where at least the first several colors in the list resemble colors that match skin tones.

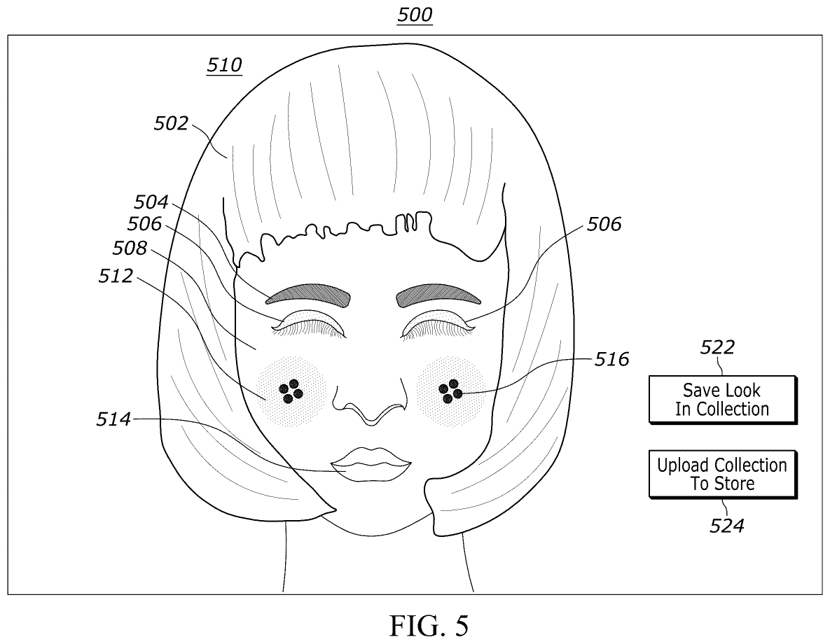

Once the makeup artist is satisfied with the design of the virtual makeup look, the makeup artist may view a preview of the virtual makeup look, for example in a preview mode. FIG. 5 illustrates an example virtual makeup look preview 500 which may be presented by the artist client device 28 via the virtual makeup configuration environment 46. The virtual makeup look preview 500 may include the virtual makeup look 510. In the example shown in FIG. 5, the virtual makeup look includes virtual hair 502, virtual eyebrows 504, virtual eye makeup 506, virtual foundation 508, virtual blush 512, virtual lipstick 514, and virtual freckles 516. Additionally, the preview 500 may include a user control 522 for saving the virtual makeup look in a collection. For example, the makeup artist may have one collection with each of their virtual makeup looks. In another example, the makeup artist may have multiple collections where each collection includes similar components. More specifically, a collection may include several makeup looks having the same components in different colors.

In response to selecting the user control 522, the virtual makeup configuration environment 46 may include user controls for saving to an existing collection or starting a new collection. In any event, the virtual makeup configuration environment 46 may store the virtual makeup look in association with the selected collection in a database, such as the database 136. The preview 500 may also include a user control 524 for uploading the virtual makeup look and/or the collection to the virtual makeup store application 44. In response to selecting the user control 524, the virtual makeup configuration environment 46 may transmit an indication to the virtual makeup look server 110 to include the virtual makeup look and/or the collection in the virtual makeup store application 44.

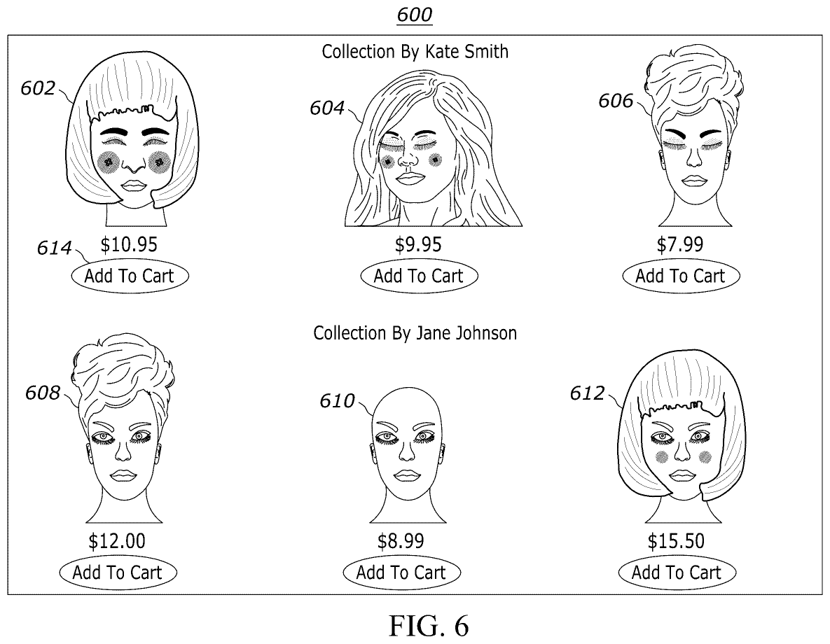

Then when a consumer opens the virtual makeup store application 44, the virtual makeup look server 110 may transmit the virtual makeup look and/or the collection to the virtual makeup store application 44 for presentation to the user. FIG. 6 illustrates an example collection display 600 which may be presented by the consumer client device 10 via the virtual makeup store application 44. The collection display 600 may present indications of virtual makeup looks 602-612 in collections from different makeup artists. The virtual makeup looks 602-612 may be selectable, such that the consumer may select a virtual makeup look 602 to view a larger version of the virtual makeup look. Additionally, the virtual makeup looks 602-612 may include prices for purchasing the virtual makeup looks 602-612 and user controls 614 for purchasing/obtaining the virtual makeup looks 602-612.

In response to selecting the user control 614, the consumer may obtain the virtual makeup look 602, and the virtual makeup store application 44 may store the virtual makeup look 602 in a user profile for the consumer. Then the consumer may apply the virtual makeup look 602 on their face or their avatar's face within the virtual makeup store application 44 and/or another application executing an AR or VR environment.

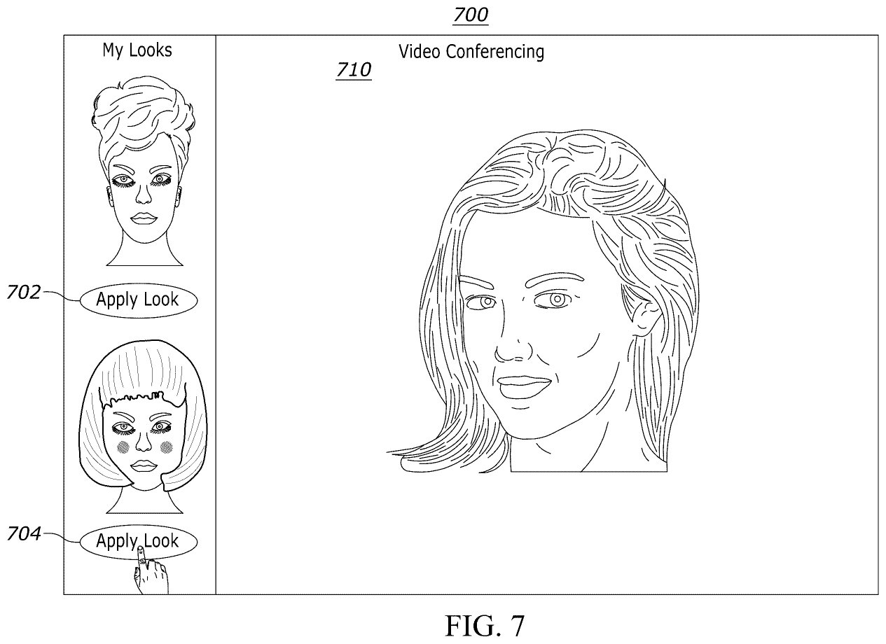

For example, the consumer may apply the virtual makeup look 602 within a video conferencing application, such that users video conferencing with the consumer may view the virtual makeup look 602 on the consumer's face. FIG. 7 illustrates an example camera view 700 of a video conferencing application which may be presented by the consumer client device 10. The video conferencing application may include user controls 702, 704 for selecting virtual makeup looks to apply to the consumer's face 710. In an example scenario, the consumer may select the user control 704 to apply the corresponding virtual makeup look.

In response to selecting the user control 704, the video conferencing application may invoke the virtual makeup API and provide an indication of the selected virtual makeup look and the camera view 700 to the virtual makeup look server 110. Then the virtual makeup look server 110 may identify facial features of the consumer 710 within the camera view 700 and adjust the virtual makeup look 704 so that components of the adjusted virtual makeup look 704 are overlaid on corresponding portions of the consumer's face 710. The virtual makeup API may then provide a response to the video conferencing application including the selected virtual makeup look overlaid on the consumer's face.

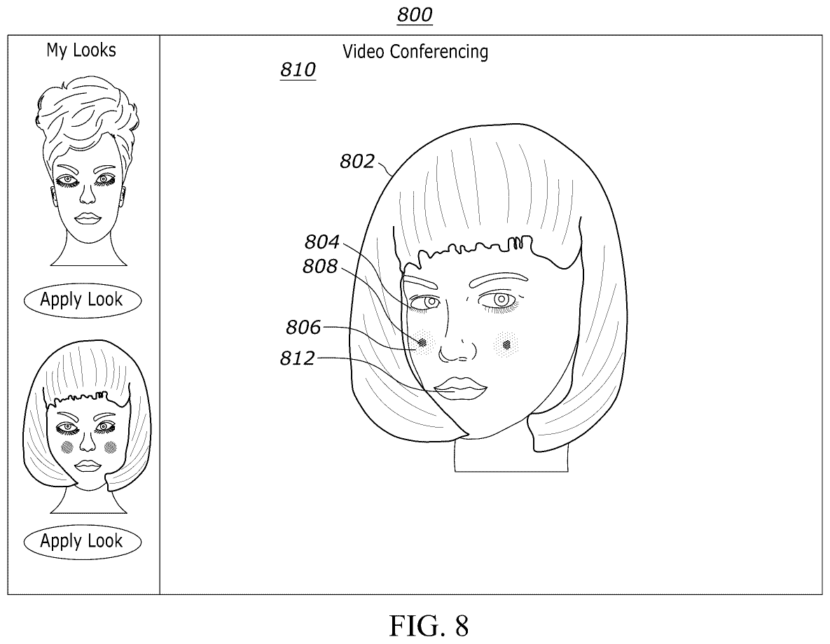

FIG. 8 illustrates an example camera view 800 of the video conferencing application which includes the selected virtual makeup look 704 applied to the consumer's face 810. As shown in FIG. 8, the video conferencing application overlays virtual hair 802, virtual eyelashes 804, virtual foundation 806, virtual blush 808, and virtual lipstick 812, on corresponding portions of the consumer's face 810. In some implementations, to overlay virtual hair, the video conferencing application and/or the virtual makeup look server 110 may identify the consumer's hair within the camera view 800. For example, the video conferencing application and/or the virtual makeup look server 110 may compare an object within the camera view 800 to template images of hair. Then the video conferencing application and/or the virtual makeup look server 110 may filter out the consumer's hair from the camera view 800 and overlay the virtual hair 802 on the surface of the consumer's head.

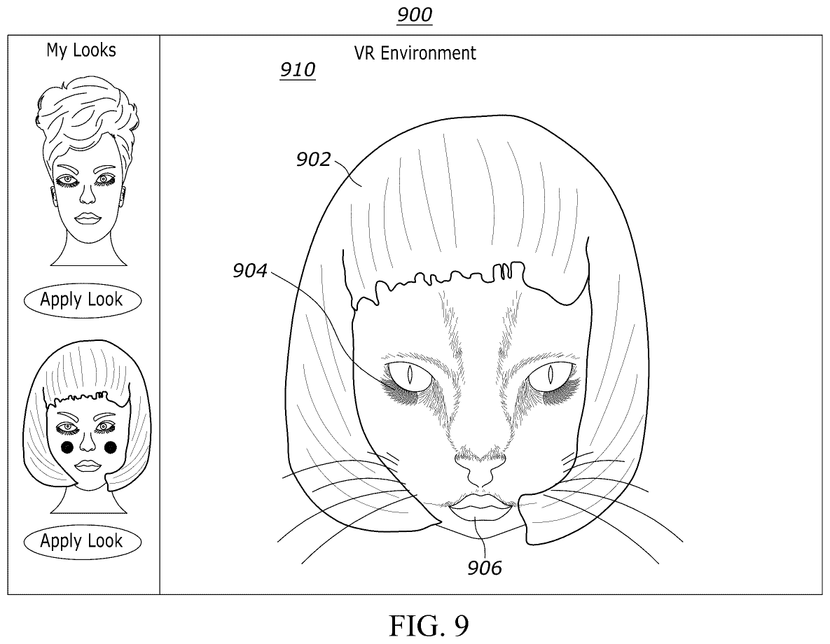

In other scenarios, the consumer may apply a virtual makeup look on their avatar's face within a virtual reality application, for example. FIG. 9 illustrates an example display 900 of a VR environment which may be presented by the consumer client device 10. As shown in FIG. 9, the VR environment overlays a virtual makeup look on the consumer's avatar. The consumer's avatar may depict a cat 910. The virtual makeup look may include virtual hair 902, virtual eyelashes 904, and virtual lipstick 906 overlaid on the cat avatar 910.

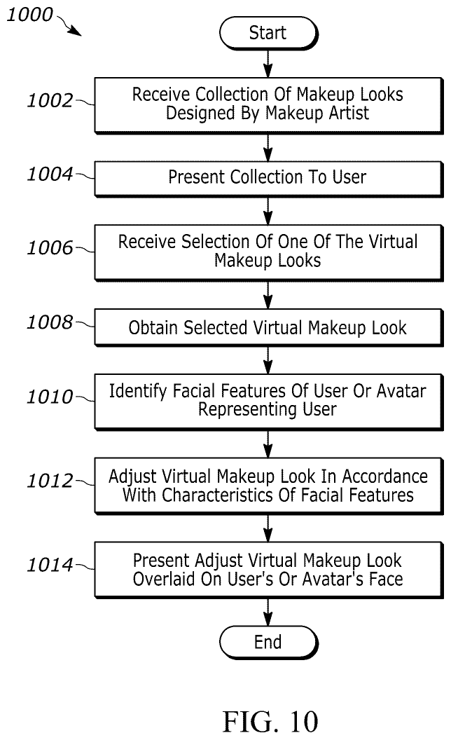

FIG. 10 illustrates a flow diagram of an example method 1000 for providing virtual makeup looks to a user. The method 1000 may be executed by the consumer client device 10. For example, the method 1000 may be executed by the virtual makeup store application 44 executing on the consumer client device.

At block 1002, the consumer client device 10 receives collection(s) of virtual makeup looks designed by makeup artist(s). For example, the consumer client device 10 may receive the collection(s) from the virtual makeup look server 110. The consumer client device 10 then presents the collection(s) to the user of the consumer client device 10 (block 1004).

For example, the consumer client device 10 may present thumbnail images of each of the virtual makeup looks in the collection(s). Then in response to receiving a selection of one of the thumbnail images, the consumer client device 10 may present an enlarged version of the virtual makeup look. In some implementations, the consumer client device 10 presents the virtual makeup look as a two-dimensional (2D) image. In other implementations, the consumer client device 10 presents the virtual makeup look as a three-dimensional (3D) image. In yet other implementations, the consumer client device 10 presents the virtual makeup look as an interactive 3D image which may be rotated, via user controls, to view the virtual makeup look from multiple angles.

The virtual makeup looks may be presented on a virtual mannequin or may be presented as standalone virtual makeup looks without overlaying them on faces. In some implementations, the user may select a user control to “try on” a virtual makeup look, and the consumer client device 10 may overlay the virtual makeup look on a camera view of the user's face.

In any event, at block 1006, the consumer client device 10 receives a selection by the user of one of the virtual makeup looks in the collection(s). For example, the consumer client device 10 may present a user control to purchase one of the virtual makeup looks and the user may select the user control to purchase the virtual makeup look. In another example, the consumer client device 10 may present a user control to “try on” one of the virtual makeup looks and the user may select the user control to “try on” the virtual makeup look.

Then at block 1008, the consumer client device 10 obtains the selected virtual makeup look for the user. The consumer client device 10 may transmit an indication of the selected virtual makeup look to the virtual makeup look server 110 to store the selected virtual makeup look in a user profile for the user. Then the user may be able to access the stored virtual makeup look and apply the stored virtual makeup look on their face or their avatar's face within the virtual makeup store application 44 or another application 211 that communicates with the virtual makeup store application 44, for example via the virtual makeup API.

The user may select a user control via the virtual makeup store application 44 or another application 211 to apply the virtual makeup look on their face or their avatar's face. The consumer client device 10 may then obtain a camera view or image from the camera of the consumer client device 10, where the camera view depicts real-world imagery of the user's face within the field of view of the camera.

The consumer client device 10 may then identify facial features within the camera view (block 1010). More specifically, the consumer client device 10 may compare features identified in the camera view to features identified in several template objects depicting facial features which are stored in the database 136, for example. The consumer client device 10 may compare features identified in the camera view 10 to the template objects using machine learning techniques.

More specifically, the consumer client device 10 may identify facial features in the camera view by detecting stable regions within the camera view that are detectable regardless of blur, motion, distortion, orientation, illumination, scaling, and/or other changes in camera perspective. The stable regions may be extracted from the template object using SIFT, SURF, FREAK BRISK, or any other suitable computer vision techniques. In some embodiments, keypoints may be located at high-contrast regions of the template object, such as edges within the template object. A bounding box may be formed around a keypoint and the portion of the camera view created by the bounding box may be a facial feature.

Additionally, the consumer client device 10 may identify characteristics of the facial feature based on characteristics of the bounding box corresponding to the facial feature. For example, the consumer client device 10 may identify the size of the facial feature as the size of the bounding box, the skin tone of the facial feature as the color within the bounding box, etc.

The consumer client device 10 may then detect facial features for the user and/or characteristics of the facial features (e.g., the size of various facial features in proportion to the user's face, skin tone, etc.) based on the comparison. In other implementations, the consumer client device 10 may transmit the camera view to the virtual makeup look server 110 which identifies the facial features.

In any event, the consumer client device 10 may adjust the virtual makeup look in accordance with the characteristics of the facial features (block 1012). More specifically, the consumer client device 10 may adjust the virtual makeup look so that components of the adjusted virtual makeup look are overlaid on corresponding portions of the consumer's face. For example, the consumer client device 10 may identify portions of the user's face, such as the user's eyes, nose, ears, mouth, hair, etc. The consumer client device 10 may then overlay components of the virtual makeup look on corresponding portions of the user's face. More specifically, the consumer client device 10 may overlay virtual lipstick on the user's lips, virtual eyelashes on the user's eyes, virtual eyebrows above the user's eyes, virtual hair on top of the user's head, etc.

Additionally, the consumer client device 10 may not overlay a component of the virtual makeup look on a corresponding portion of the user's face if the user is missing the corresponding portion. For example, if the user is missing one of their eyes, the consumer client device 10 may not overlay a virtual eyelash, virtual eye shadow, virtual mascara, virtual eye shadow, virtual eye liner, etc., for the missing eye.

In another example, to overlay virtual hair, the consumer client device 10 may identify the user's hair within the camera view. Then the consumer client device 10 may filter out the user's hair from the camera view and overlay the virtual hair on the surface of the user's head. In yet another example, to overlay virtual facial hair, the consumer client device 10 may identify portions of the user's face for the virtual facial hair, such as the user's jaw, chin, upper lip, cheek, etc. Then the consumer client device 10 may overlay the virtual facial hair on the identified portions of the user's face.

In yet another example, the consumer client device 10 may adjust the colors of the virtual makeup look in accordance with the user's skin tone. The makeup artist may select specific colors for the virtual makeup look or ranges of colors for the virtual makeup look. Then the consumer client device 10 may select a color within the range which matches the user's skin tone. In other implementations, the consumer client device 10 may select colors which are closest to the colors selected by the makeup artist that match the user's skin tone.

In some scenarios, when the virtual makeup look does not include virtual facial hair and the user has facial hair, the virtual makeup look may overlay a skin tone on the user's facial hair that matches the user's skin tone. More specifically, the consumer client device 10 may identify colors matching the remaining portions of the user's face that do not include facial hair. For example, the consumer client device 10 may identify the colors/skin tone of the user's cheeks, forehead, nose, etc. Then the consumer client device 10 may overlay the identified colors/skin tone on the user's facial hair to filter the user's facial hair from the camera view so that it does not appear that the user has facial hair. In some implementations, the makeup artist may select a user control to remove facial hair when the artist designs the virtual makeup look. In other implementations, facial hair may be removed by default if the virtual makeup look does not include virtual facial hair.

In some implementations, the consumer client device 10 may identify facial features for the user's avatar and adjust the virtual makeup look in accordance with the characteristics of the facial features of the user's avatar. The consumer client device 10 may receive an image of the consumer's avatar used in a VR environment. The consumer client device 10 may then detect facial features within the image.

As mentioned above, the consumer client device 10 may train a first machine learning model for identifying facial features of consumers using a first set of template objects. The consumer client device 10 may also train a second machine learning model for identifying facial features of avatars using a second set of template objects. The first and second machine learning models may be separate machine learning models trained using different training sets.

In any event, the consumer client device 10 may then detect facial features for the avatar and/or characteristics of the facial features (e.g., the size of various facial features in proportion to the avatar's face, skin tone, etc.) based on the comparison. Then the consumer client device 10 may adjust the virtual makeup look so that components of the adjusted virtual makeup look are overlaid on corresponding portions of the avatar's face.

In other implementations, the virtual makeup look server 110 may adjust the virtual makeup look in accordance with characteristics of the user's or avatar's facial features. Then the virtual makeup look server 110 may provide the adjusted virtual makeup look to the consumer client device 10.

The consumer client device 10 may then store the adjusted virtual makeup look for the user's or avatar's face in the user profile. In this manner, the virtual makeup store application 44 or another application that applies the virtual makeup look does not need to recreate the adjusted virtual makeup look each time the user wants to apply the virtual makeup look.

At block 1014, the consumer client device 10 presents the adjusted virtual makeup look overlaid on the user's or avatar's face. The consumer client device 10 may present the adjusted virtual makeup look in an AR or VR environment, such that the adjusted virtual makeup look is viewable from a camera view or virtual reality environment on another user's client device.

When the user moves within the camera view or the avatar moves within the VR environment, the consumer client device 10 may detect movement of the user's or avatar's facial features. For example, the consumer client device 10 may obtain video from the camera or video images from the VR environment and may compare the video frames to detect a change in position of the user or avatar. Then the consumer client device 10 may move corresponding components of the adjusted virtual makeup look in accordance with the movement of the facial features, so that the corresponding components remain at the same position relative to the user's or the avatar's face. In this manner, the adjusted virtual makeup look appears as if it has been placed directly on the user's or avatar's face and may be indistinguishable from applying real-world makeup to the user.

Also in some implementations, the user may switch between applying the virtual makeup look to their face and applying the virtual makeup look to their avatar's face. For example, at one point in time, the consumer client device 10 may receive a request to use the adjusted virtual makeup look in an AR environment on the user's face. Accordingly, the consumer client device 10 may present the adjusted virtual makeup look overlaid on the user's face in the AR environment. At another point in time, the consumer client device 10 may receive a request to use the adjusted virtual makeup look in a VR environment on the avatar's face. Accordingly, the consumer client device 10 may present the adjusted virtual makeup look overlaid on the avatar's face in the VR environment.

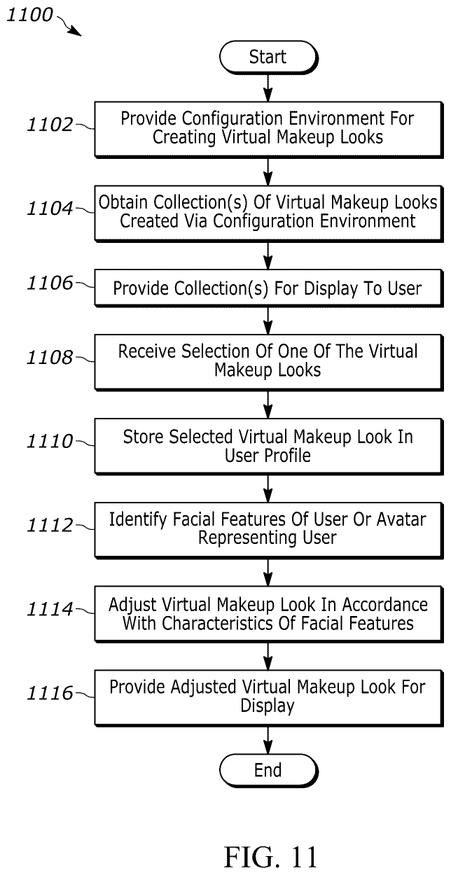

FIG. 11 illustrates a flow diagram of an example method 1100 for providing virtual makeup looks to users. The method 1100 may be executed by the virtual makeup look server 110. For example, the method 1100 may be executed by the makeup look generation engine 134 executing on the virtual makeup look server 110.

At block 1102, the virtual makeup look server 110 provides a configuration environment for creating virtual makeup looks. For example, the virtual makeup look server 110 may provide a virtual makeup configuration environment 46 to an artist client device 28. The virtual makeup configuration environment 46 may include a set of tools for designing a virtual makeup look. The set of tools may include user controls for selecting types of virtual makeup such as virtual mascara, virtual eye shadow, virtual eye liner, virtual contour, virtual blush, virtual lipstick, virtual foundation, virtual concealer, virtual bronzer, etc. The set of tools may also include user controls for selecting colors, virtual hairstyles, virtual facial hair, virtual eyebrows, virtual freckles, virtual eyelashes, etc. Additionally, the set of tools may include user controls for selecting relative positions of each component of the virtual makeup look within a face. For example, the configuration environment may present a virtual mannequin to preview the virtual makeup look on.

Then at block 1104, the virtual makeup look server 110 obtains collection(s) of virtual makeup looks created via the configuration environment. For example, the virtual makeup look server 110 may obtain multiple collections from multiple artists on multiple artist client devices 28. A makeup artist may select a user control for uploading a virtual makeup look and/or a collection to the virtual makeup store application 44. In response to selecting the user control, the virtual makeup configuration environment 46 may transmit an indication to the virtual makeup look server 110 to include the virtual makeup look and/or the collection in the virtual makeup store application 44.

At block 1106, the virtual makeup look server 110 provides the collection(s) of virtual makeup looks designed by makeup artist(s). For example, the virtual makeup look server 110 may provide the collection(s) to a consumer client device 10 for display to a user via the virtual makeup store application 44.

For example, the consumer client device 10 may present thumbnail images of each of the virtual makeup looks in the collection(s). Then in response to receiving a selection of one of the thumbnail images, the consumer client device 10 may present an enlarged version of the virtual makeup look.

Then at block 1108, the virtual makeup look server 110 receives a selection by the user of one of the virtual makeup looks in the collection(s). For example, the consumer client device 10 may present a user control to purchase one of the virtual makeup looks and the user may select the user control to purchase the virtual makeup look. In another example, the consumer client device 10 may present a user control to “try on” one of the virtual makeup looks and the user may select the user control to “try on” the virtual makeup look. The consumer client device 10 then provides the selection of virtual makeup look to the virtual makeup look server 110.

At block 1110, the virtual makeup look server 110 stores the selected virtual makeup look in a user profile for the user. Then the user may be able to access the stored virtual makeup look and apply the stored virtual makeup look on their face or their avatar's face within the virtual makeup store application 44 or another application 211 that communicates with the virtual makeup store application 44, for example via the virtual makeup API.

The user may select a user control via the virtual makeup store application 44 or another application 211 to apply the virtual makeup look on their face or their avatar's face. The consumer client device 10 may then obtain a camera view or image from the camera of the consumer client device 10, where the camera view depicts real-world imagery of the user's face within the field of view of the camera. Then the consumer client device 10 may provide the camera view to the virtual makeup look server 110. The virtual makeup look server 110 may receive the camera view which includes a graphical representation of the user's face.

At block 1112, the virtual makeup look server 110 may identify facial features within the camera view. More specifically, the virtual makeup look server 110 may compare features identified in the camera view to features identified in several template objects depicting facial features which are stored in the database 136, for example. The virtual makeup look server 110 may compare features identified in the camera view 10 to the template objects using machine learning techniques.

The virtual makeup look server 110 may then detect facial features for the user and/or characteristics of the facial features (e.g., the size of various facial features in proportion to the user's face, skin tone, etc.) based on the comparison.

At block 1114, the virtual makeup look server 110 may adjust the virtual makeup look in accordance with the characteristics of the facial features. More specifically, the virtual makeup look server 110 may adjust the virtual makeup look so that components of the adjusted virtual makeup look are overlaid on corresponding portions of the consumer's face. For example, the virtual makeup look server 110 may identify portions of the user's face, such as the user's eyes, nose, ears, mouth, hair, etc. The virtual makeup look server 110 may then overlay components of the virtual makeup look on corresponding portions of the user's face. More specifically, the virtual makeup look server 110 may overlay virtual lipstick on the user's lips, virtual eyelashes on the user's eyes, virtual eyebrows above the user's eyes, virtual hair on top of the user's head, etc.

Additionally, the virtual makeup look server 110 may not overlay a component of the virtual makeup look on a corresponding portion of the user's face if the user is missing the corresponding portion. For example, if the user is missing one of their eyes, the virtual makeup look server 110 may not overlay a virtual eyelash, virtual eye shadow, virtual mascara, virtual eye shadow, virtual eye liner, etc., for the missing eye.

In some implementations, the virtual makeup look server 110 may identify facial features for the user's avatar and adjust the virtual makeup look in accordance with the characteristics of the facial features of the user's avatar. The virtual makeup look server 110 may receive an image including a graphical representation of the consumer's avatar used in a VR environment. The virtual makeup look server 110 may then detect facial features within the image.

As mentioned above, the virtual makeup look server 110 may train a first machine learning model for identifying facial features of consumers using a first set of template objects. The virtual makeup look server 110 may also train a second machine learning model for identifying facial features of avatars using a second set of template objects. The first and second machine learning models may be separate machine learning models trained using different training sets.

In any event, the virtual makeup look server 110 may then detect facial features for the avatar and/or characteristics of the facial features (e.g., the size of various facial features in proportion to the avatar's face, skin tone, etc.) based on the comparison. Then the virtual makeup look server 110 may adjust the virtual makeup look so that components of the adjusted virtual makeup look are overlaid on corresponding portions of the avatar's face.

The virtual makeup look server 110 may then store the adjusted virtual makeup look for the user's or avatar's face in the user profile. In this manner, the virtual makeup store application 44 or another application that applies the virtual makeup look does not need to recreate the adjusted virtual makeup look each time the user wants to apply the virtual makeup look.

At block 1116, the virtual makeup look server 110 provides the adjusted virtual makeup look to the consumer client device 10 for display, where the adjusted virtual makeup look is overlaid on the user's or avatar's face. The consumer client device 10 may present the adjusted virtual makeup look in an AR or VR environment, such that the adjusted virtual makeup look is viewable from a camera view or virtual reality environment on another user's client device.

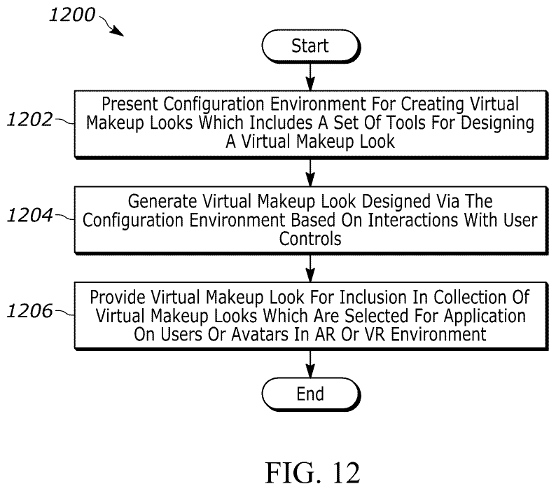

FIG. 12 illustrates a flow diagram of an example method 1200 for configuring virtual makeup looks. The method 1200 may be executed by the artist client device 28. For example, the method 1200 may be executed by the virtual makeup configuration environment 46 executing on the artist client device 28.

At block 1202, the artist client device presents a configuration environment for creating virtual makeup looks. For example, the virtual makeup look server 110 may provide a virtual makeup configuration environment 46 to the artist client device 28. The virtual makeup configuration environment 46 may include a set of tools for designing a virtual makeup look. The set of tools may include user controls for selecting types of virtual makeup such as virtual mascara, virtual eye shadow, virtual eye liner, virtual contour, virtual blush, virtual lipstick, virtual foundation, virtual concealer, virtual bronzer, etc. The set of tools may also include user controls for selecting colors, virtual hairstyles, virtual facial hair, virtual eyebrows, virtual freckles, virtual eyelashes, etc. Additionally, the set of tools may include user controls for selecting relative positions of each component of the virtual makeup look within a face. For example, the configuration environment may present a virtual mannequin (also referred to herein as a “virtual face”) to preview the virtual makeup look on.

The virtual makeup configuration environment 46 may also include a configuration canvas which may present a view of the components of the design of the virtual makeup look as the artist creates the design. In some implementations, the configuration canvas may include a virtual face for the makeup artist to overlay virtual makeup components on. Still further, the virtual makeup configuration environment 46 may include an editing pane for editing properties of each type of virtual makeup. For example, the editing pane may include user controls for adjusting the colors for each type of virtual makeup.

In some implementations, the editing pane may include user controls for selecting variations of a component of the virtual makeup look for different skin tones, such that the virtual makeup look is adapted to a user's skin tone. For example, the makeup artist may select a range of colors for the virtual makeup look. Then when a user obtains the virtual makeup look and applies the virtual makeup look, the consumer client device 10 may select a color within the range which matches the user's skin tone.

At block 1204, the artist client device 28 may generate a virtual makeup look designed via the configuration environment 46 based on the makeup artist interacting with the user controls. For example, the makeup artist may select virtual makeup components by dragging and dropping the virtual makeup components into the configuration canvas. The makeup artist may place the virtual makeup components at corresponding locations on the virtual mannequin and/or relative locations with respect to each other. In this manner, the designed virtual makeup look may include the virtual makeup components selected by the makeup artist at the respective locations in which they are placed on the virtual mannequin and/or relative to each other.

The makeup artist may select properties of the virtual makeup components included in the virtual makeup look via the editing pane. For example, the makeup artist may select colors for virtual lipstick, virtual blush, virtual foundation, virtual bronzer, etc.

Once the makeup artist is satisfied with the design of the virtual makeup look, the makeup artist may view a preview of the virtual makeup look, for example in a preview mode. In some implementations, the artist client device 28 may include a user control for saving the virtual makeup look in a collection. For example, the makeup artist may have one collection with each of their virtual makeup looks. In another example, the makeup artist may have multiple collections where each collection includes similar components. More specifically, a collection may include several makeup looks having the same components in different colors.

In response to selecting the user control, the virtual makeup configuration environment 46 may store the virtual makeup look in association with the selected collection in a database, such as the database 136. The artist client device 28 may also include a user control for uploading the virtual makeup look and/or the collection to the virtual makeup store application 44. In response to selecting the user control, the artist client device 28 may provide the virtual makeup look for inclusion in the collection of virtual makeup looks which can be selected by users and applied on the users or on the users' avatars in an AR or VR environment (block 1206). For example, the artist client device 28 may transmit an indication to the virtual makeup look server 110 to include the virtual makeup look and/or the collection in the virtual makeup store application 44.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A method for providing virtual makeup looks to a user, the method comprising:
receiving, by one or more processors, a collection of virtual makeup looks designed by a makeup artist;
presenting, by the one or more processors via a user interface, the collection of virtual makeup looks for a user to select from;
receiving, at the one or more processors, a selection by the user of one of the virtual makeup looks in the collection;
in response to receiving the selection, obtaining, by the one or more processors, the selected virtual makeup look for the user;
identifying, by the one or more processors, facial features of the user in a camera view or facial features of an avatar representing the user in a virtual reality environment;
adjusting, by the one or more processors, the virtual makeup look in accordance with characteristics of the facial features of the user or the avatar; and
presenting, by the one or more processors, the adjusted virtual makeup look overlaid on the user's or the avatar's face, such that components of the adjusted virtual makeup look are overlaid on corresponding portions of the user's or the avatar's face.

2. The method of claim 1, wherein presenting the adjusted virtual makeup look overlaid on the user's or the avatar's face includes:
detecting, by the one or more processors, movement of one or more of the facial features of the user or the avatar; and
moving, by the one or more processors, one or more corresponding components of the adjusted virtual makeup look in accordance with the movement of the one or more facial features so that the one or more corresponding components remain at a same position relative to the user's or the avatar's face.

3. The method of claim 1, wherein adjusting the virtual makeup look in accordance with characteristics of the facial features of the user or the avatar includes:
adjusting, by the one or more processors, one or more colors of the virtual makeup look in accordance with a skin tone of the user's or the avatar's face.

4. The method of claim 1, wherein the virtual makeup look includes virtual hair and wherein adjusting the virtual makeup look in accordance with characteristics of the facial features of the user or the avatar includes:
identifying, by the one or more processors, the user's or the avatar's hair within the camera view or the virtual reality environment;
filtering, by the one or more processors, the user's or the avatar's hair from the camera view or the virtual reality environment; and
overlaying, by the one or more processors, the virtual hair on a surface of the user's or the avatar's head.

5. The method of claim 1, wherein presenting the adjusted virtual makeup look includes:
at a first point in time:
receiving, by the one or more processors, a request by the user to use the adjusted virtual makeup look in an augmented reality environment; and
presenting, by the one or more processors, the adjusted virtual makeup look overlaid on the user's face in the augmented reality environment; and
at a second point in time:
receiving, by the one or more processors, a request by the user to use the adjusted virtual makeup look in the virtual reality environment; and
presenting, by the one or more processors, the adjusted virtual makeup look overlaid on the avatar's face in the virtual reality environment.

6. The method of claim 1, wherein the virtual makeup look does not include facial hair, wherein identifying facial features of the user includes identifying facial hair on the user's face, and further comprising:
overlaying, by the one or more processors, a portion of the user's face that includes facial hair with colors matching remaining portions of the user's face to filter the user's facial hair from the camera view.

7. The method of claim 1, wherein the adjusted virtual makeup look overlaid on the user's or the avatar's face is viewable from a camera view or virtual reality environment on another user's client device.

8. The method of claim 1, wherein adjusting the virtual makeup look in accordance with characteristics of the facial features of the avatar includes:
determining, by the one or more processors, that the user's avatar is missing at least one facial feature; and
adjusting, by the one or more processors, the virtual makeup look to omit a component of the virtual makeup look on a corresponding portion of the avatar's face.

9. The method of claim 1, wherein the components of the virtual makeup look includes one or more of: virtual hair, virtual eyelashes, virtual mascara, virtual eye shadow, virtual eye liner, virtual eyebrows, virtual contour, virtual blush, virtual lipstick, virtual freckles, virtual foundation, virtual concealer, virtual bronzer, or virtual facial hair.

10. A method for providing virtual makeup looks to users, the method comprising:
providing, by one or more processors, a configuration environment for creating virtual makeup looks to one or more makeup artists;
obtaining, by the one or more processors, one or more collections of virtual makeup looks from the one or more makeup artists created via the configuration environment;
providing, by the one or more processors, the one or more collections for display to a user;
receiving, by the one or more processors, a selection from the user of one of the virtual makeup looks in the one or more collections;
storing, by the one or more processors, the selected virtual makeup look in a user profile for the user;
in response to receiving a request to apply the selected virtual makeup look, identifying, by the one or more processors, facial features of the user in a camera view or facial features of an avatar representing the user in a virtual reality environment;
adjusting, by the one or more processors, the virtual makeup look in accordance with characteristics of the facial features of the user or the avatar; and
providing, by the one or more processors, the adjusted virtual makeup look for display, such that components of the adjusted virtual makeup look are overlaid on corresponding portions of the user's or the avatar's face.

11. The method of claim 10, wherein presenting the adjusted virtual makeup look includes:
at a first point in time:
receiving, by the one or more processors, a request by the user to use the adjusted virtual makeup look in an augmented reality environment; and
providing, by the one or more processors, the adjusted virtual makeup look for display overlaid on the user's face in the augmented reality environment; and
at a second point in time:
receiving, by the one or more processors, a request by the user to use the adjusted virtual makeup look in the virtual reality environment; and
providing, by the one or more processors, the adjusted virtual makeup look for display overlaid on the avatar's face in the virtual reality environment.

12. The method of claim 10, further comprising:
receiving, at the one or more processors, a graphical representation of the user's or the avatar's face for identifying the facial features.

13. The method of claim 12, wherein adjusting the virtual makeup look in accordance with characteristics of the facial features of the user or the avatar includes:
adjusting, by the one or more processors, one or more colors of the virtual makeup look in accordance with a skin tone of the user's or the avatar's face.

14. The method of claim 10, wherein the components of the virtual makeup look includes one or more of: virtual hair, virtual eyelashes, virtual mascara, virtual eye shadow, virtual eye liner, virtual eyebrows, virtual contour, virtual blush, virtual lipstick, virtual freckles, virtual foundation, virtual concealer, virtual bronzer, or virtual facial hair.

15. A method for configuring virtual makeup looks, the method comprising:
presenting, by one or more processors, a configuration environment to a makeup artist for creating virtual makeup looks, the configuration environment including a set of tools for designing a virtual makeup look, wherein the set of tools includes user controls for selecting one or more types of makeup, one or more colors, or one or more hairstyles, and for selecting relative positions of each component of the virtual makeup look within a face;
generating, by the one more processors, a virtual makeup look designed by the makeup artist via the configuration environment based on interactions with the user controls by the makeup artist; and
providing, by the one or more processors, the virtual makeup look for inclusion in a collection of virtual makeup looks, each of which is selectable by users for application on the users' faces in an augmented reality environment or on the users' avatars in a virtual reality environment.

16. The method of claim 15, wherein presenting the configuration environment includes:
presenting, by the one or more processors, a configuration canvas for viewing a preview of the virtual makeup look on a virtual face; and
in response to receiving a selection of a component of the virtual makeup look, presenting, by the one or more processors, the component of the virtual makeup look on the virtual face in the configuration canvas.

17. The method of claim 16, further comprising:
receiving, by the one or more processors, a selection of a location in which to place the component of the virtual makeup look within the virtual face; and
presenting, by the one or more processors, the component of the virtual makeup look at the selected location on the virtual face.

18. The method of claim 16, further comprising:
receiving, by the one or more processors, a selection of a color for the component of the virtual makeup look; and
presenting, by the one or more processors, the component of the virtual makeup look with the selected color.

19. The method of claim 15, further comprising:
providing, by the one or more processors, user controls for selecting variations of a component of the virtual makeup look for different skin tones, such that the virtual makeup look is adapted to a user's skin tone.

20. The method of claim 15, wherein the components of the virtual makeup look includes one or more of: virtual hair, virtual eyelashes, virtual mascara, virtual eye shadow, virtual eye liner, virtual eyebrows, virtual contour, virtual blush, virtual lipstick, virtual freckles, virtual foundation, virtual concealer, virtual bronzer, or virtual facial hair.
